(19) United States
(12) Patent Application Publication
(10) Pub. No.: US 2015/0009662 A1
(43) Pub. Date: Jan. 8, 2015

(54) Light-Emitting Module and Luminaire

(71) Applicant: Toshiba Lighting & Technology Corporation, Yokosuka-shi (JP)

(72) Inventors: Soichi Shibusawa, Yokosuka-shi (JP); Kozo Uemura, Yokosuka-shi (JP); Yumiko Hayashida, Yokosuka-shi (JP)

(73) Assignee: TOSHIBA LIGHTING & TECHNOLOGY CORPORATION, Yokosuka-shi (JP)

(21) Appl. No.: 14/198,777

(22) Filed: Mar. 6, 2014

(30) Foreign Application Priority Data
Jul. 3, 2013 (JP) 2013-140074

(51) Int. Cl. F21S 4/00

(52) U.S. Cl. CPC F21S 4/008
USPC 362/217.14

(57) ABSTRACT

According to one embodiment, a light-emitting module includes N light-emitting elements, which are a first group of light-emitting elements, on the front surface of a substrate. The N light-emitting elements are disposed in a row in a longitudinal direction from one end portion to the other end portion of the substrate. The N light-emitting elements are connected in series. The light-emitting module includes a metal member provided in the longitudinal direction of the substrate in a position not overlapping a conductive line on the rear surface of the substrate. The conductive line is connected to, via a through-hole, a conductive line configured to connect the N light-emitting elements.

### CROSS-REFERENCE TO RELATED APPLICATIONS

This application is based upon and claims the benefit of priorities from Japanese Patent Application No. 2013-140074 filed on Jul. 3, 2013; the entire contents of which are incorporated herein by reference.

### FIELD

Embodiments described herein relate to a light-emitting module and a luminaire.

### BACKGROUND

In recent years, as a light-emitting module including an LED (light-emitting diode), a light-emitting module of a chip on board (COB) type is generally used in which a plurality of LED chips are mounted on a substrate.

The light-emitting module of the COB type is used in, for example, a bulb-type LED lamp. In the bulb-type LED lamp, a combined mounting type light-emitting module is used in which a flow stop is formed on a substrate on which a plurality of LED chips are combined and mounted and phosphor resin is poured into a space formed by the flow stop and is hardened.

In recent years, the light-emitting module of the COB type is also used in a straight tube type LED lamp (e.g., JP-A-2012-146470). In the straight tube type LED lamp, a light-emitting module is used in which LED chips are provided side by side in a row at equal intervals on a substrate. The straight tube type LED lamp usually has an elongated shape. Therefore, in the straight tube type LED lamp, a plurality of light-emitting modules having an elongated shape are connected and used.

Some straight tube type LED lamp for base illumination has length as large as four feet. Therefore, it is demanded to increase the length of a light-emitting module.

However, when the length of the light-emitting module is increased, a substrate for the light-emitting module tends to bend. Therefore, it is likely that the light-emitting module tends to be deteriorated.

### BRIEF DESCRIPTION OF THE DRAWINGS

FIG. 1 is a perspective view showing a luminaire according to an embodiment;

FIG. 2 is a sectional view of the luminaire shown in FIG. 1;

FIG. 3 is a connection diagram of the luminaire shown in FIG. 1;

FIG. 4 is a diagram showing an example of a light-emitting module according to the embodiment;

FIG. 5 is a diagram showing the example of the light-emitting module; and

FIG. 6 is a sectional view of the light-emitting module taken along line A-A in FIGS. 4 and 5.

### DETAILED DESCRIPTION

It is an object of embodiments to provide a light-emitting module and a luminaire that can suppress a bend of a substrate.

A light-emitting module and a luminaire according to an embodiment are explained below with reference to the drawings. In the embodiment, components having the same functions are denoted by the same reference numerals and signs and redundant explanation of the components is omitted. The light-emitting module and the luminaire explained in the embodiment below are explained as only an example and do not limit the present invention.

In the embodiment, the light-emitting module includes a substrate formed of insulative resin and a first group of light-emitting elements disposed in a longitudinal direction from a first end portion to a second end portion of the substrate on a first surface of the substrate, the light-emitting elements of the first group being connected in series to one another. Further, the light-emitting module includes a second conductive line disposed from the one end portion to the second end portion on a second surface of the substrate on the opposite side of the first surface and electrically connected to, via a first through-hole, a first conductive line configured to connect the light-emitting elements of the first group on the first surface and an electrically nonconductive metal member disposed in the longitudinal direction in a position not overlapping the second conductive line on the second surface.

With the configuration of the light-emitting module, the substrate can be reinforced by the metal member that is not electrically connected to the first group of light-emitting elements. Therefore, it is possible to suppress a bend of the substrate without deteriorating light emission efficiency of the first group of light emitting elements. The second conductive line equivalent to a return conductive line in a circuit corresponding to the first group of light-emitting elements can be distributed on the second surface of the substrate. Therefore, it is possible to reduce the width in a latitudinal direction of the substrate. That is, it is possible to reduce the size of the light-emitting module.

On the second surface of the substrate, the second conductive line is disposed more on the other end side than one end side in a latitudinal direction of the substrate. The metal member is disposed more in a region on one end side of the second surface.

With the configuration of the light-emitting module, it is possible to dispose the metal member broadly in a free space where the second conductive line is not disposed. Consequently, since the substrate can be efficiently reinforced, it is possible to efficiently prevent a bend of the substrate.

The light-emitting module includes a second group of light-emitting elements disposed in the longitudinal direction on the first surface of the substrate, the light-emitting elements of the second group being connected in series to one another. The light-emitting module includes a fourth conductive line disposed from the first end portion to the second end portion on the second surface and electrically connected to, via a second through-hole, a third conductive line configured to connect the light-emitting elements of the second group on the first surface. The metal member is also disposed in a region of the second surface between the second conductive line and the fourth conductive line.

With the configuration of the light-emitting module, it is possible to suppress migration (corrosion) of the second conductive line and the fourth conductive line.

The first group of light-emitting elements and the second group of light-emitting elements have different light emission colors.

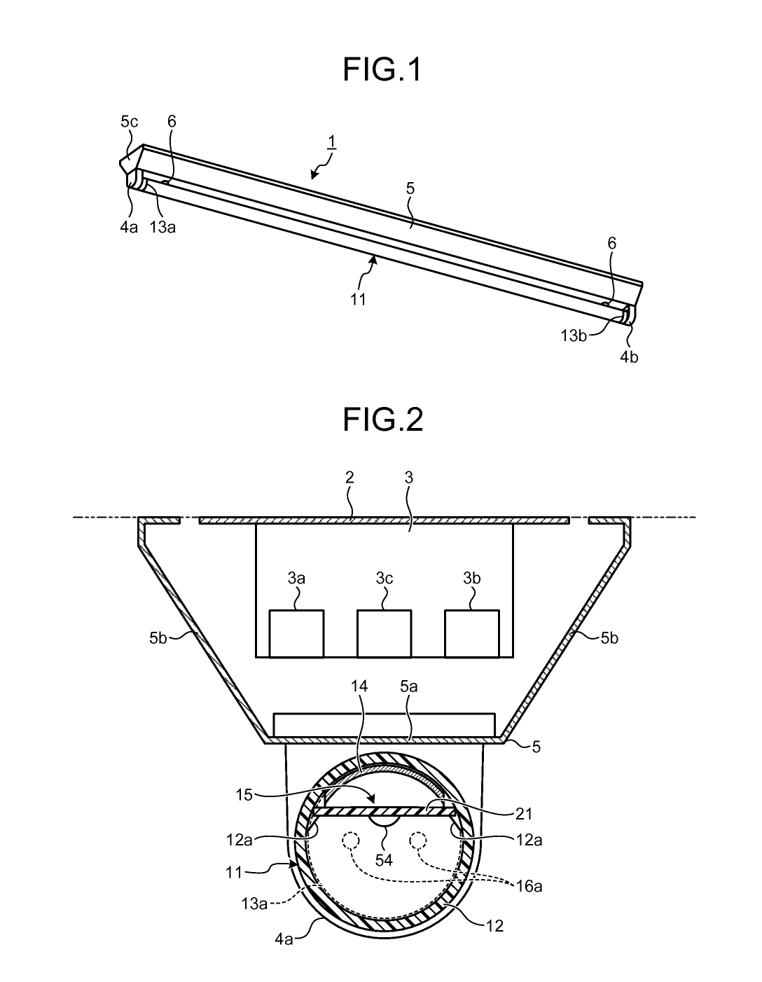

FIG. 1 is a perspective view depicting a luminaire according to an embodiment. FIG. 2 is a sectional view of the luminaire depicted in FIG. 1.

In FIG. 1, a luminaire 1 includes a luminaire main body (a device main body) 2, a lighting circuit 3, first and second sockets 4a and 4b formed in a pair, a reflecting member 5, and a straight tube type lamp 11 forming a light source.

The luminaire main body 2 depicted in FIG. 2 is made of, for example, a metal plate having an elongated shape. The luminaire main body 2 extends in the front back direction on the paper surface on which FIG. 2 is drawn. The luminaire main body 2 is fixed to, for example, a ceiling in a room using a not-shown plurality of screws.

The lighting circuit 3 is fixed to an intermediate portion in a longitudinal direction of the luminaire main body 2. The lighting circuit 3 includes a first lighting circuit 3a, a second lighting circuit 3b, and a control circuit 3c.

According to control by the control circuit 3c, the first lighting circuit 3a receives a commercial alternating-current power supply, generates a direct-current output, and supplies the direct-current output to light-emitting elements 45a of the lamp 11 explained below. According to the control by the control circuit 3c, the second lighting circuit 3b receives the commercial alternating-current power supply, generates a direct-current output, and supplies the direct-current output to light-emitting elements 45b of the lamp 11 explained below.

The control circuit 3c controls an electric current flowing to the light-emitting elements 45a and the light-emitting elements 45b, which emit lights of different colors, and controls luminous intensity of the lights respectively emitted from the light-emitting elements 45a and the light-emitting elements 45b. Consequently, the control circuit 3c performs control of a color and control of brightness of light obtained by mixing the light emitted from the light-emitting elements 45a and the light emitted from the light-emitting elements 45b. Specifically, the control circuit 3c controls the magnitude of an electric current supplied from the first lighting circuit 3a to the light-emitting elements 45a and controls the magnitude of an electric current supplied from the second lighting circuit 3b to the light-emitting elements 45b to perform control of a color and control of brightness of light obtained by mixing light emitted from the light-emitting elements 45a and light emitted from the light-emitting elements 45b. A rectifying function is imparted to the first lighting circuit 3a and the second lighting circuit 3b herein. However, the rectifying function is not limited to this and may be imparted to the lamp 11 explained below.

A power supply terminal block, a plurality of member supporting metal fittings, a pair of socket supporting members, and the like, which are not shown in the figure, are attached to the luminaire main body 2. A power supply line of the commercial alternating-current power supply drawn in from an attic is connected to the power supply terminal block. Further, the power supply terminal block is electrically connected to the lighting circuit 3 through a not-shown intra-device wire.

The sockets 4a and 4b are coupled to the socket supporting members and respectively disposed at both end portions in the longitudinal direction of the luminaire main body 2. The sockets 4a and 4b are sockets of a rotary mounting type.

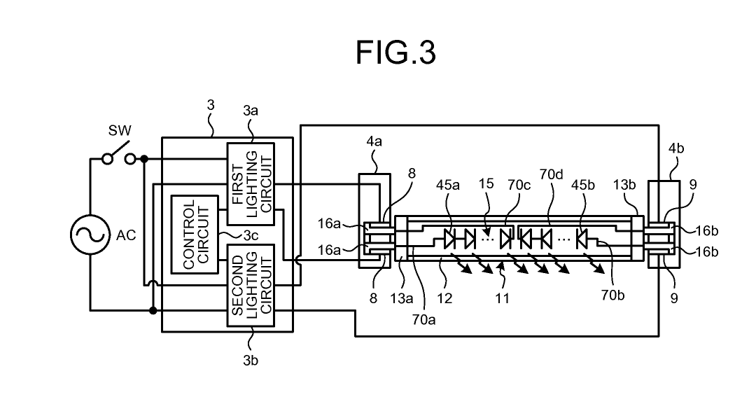

FIG. 3 is a connection diagram of the luminaire depicted in FIG. 1. The sockets 4a and 4b include pairs of terminal metal fittings 8 and 9 to which lamp pins 16a and 16b explained below are connected. In order to supply electric power to the lamp 11 explained below, the two terminal metal fittings 8 of the first socket 4a are connected to the first lighting circuit 3a via the intra-device wire. The two terminal metal fittings 8 of the first socket 4a are connected to the second lighting circuit 3b via the intra-device wire.

As depicted in FIG. 2, the reflecting member 5 includes, for example, a bottom plate section 5a, side plate sections 5b, and end plates 5c made of metal and is formed in a trough shape opened in the upper surface. The bottom plate section 5a is flat. The side plate sections 5b are bent obliquely upward from both ends in the width direction of the bottom plate section 5a. The end plates 5c close end face openings formed by ends in a longitudinal direction of the bottom plate section 5a and the side plate sections 5b. A metal plate forming the bottom plate section 5a and the side plate sections 5b is made of a color steel plate, the surface of which assumes a whitish color. Therefore, the surfaces of the bottom plate section 5a and the side plate sections 5b are reflection surfaces. Not-shown socket through-holes are respectively opened at both end portions in the longitudinal direction of the bottom plate section 5a.

The reflecting member 5 covers the luminaire main body 2 and components attached to the luminaire main body 2. This state is retained by detachable decoration screws 6 (see FIG. 1). The decoration screws 6 are screwed into the member supporting metal fittings piercing through the bottom plate section 5a upward. The decoration screws 6 can be manually turned without using a tool. The sockets 4a and 4b are projected to the lower side of the bottom plate section 5a through the socket through-holes.

The luminaire 1 is not limited to a configuration for supporting only one lamp 11 explained below and can include, for example, two pairs of sockets and support two lamps 11.

The lamp 11 detachably supported by the sockets 4a and 4b is explained below with reference to FIGS. 2 to 6.

The lamp 11 has a dimension and an outer diameter same as the dimension and the outer diameter of an existing fluorescent lamp. The lamp 11 includes a pipe 12, a first cap 13a and a second cap 13b attached to both ends of the pipe 12, a beam 14, and a light-emitting module 15. For example, the lamp 11 includes a plurality of, for example, four light-emitting modules 15 in a state in which the light-emitting modules 15 are arranged in a row in a longitudinal direction of the light-emitting modules 15 and coupled in series.

The pipe 12 is formed of a translucent resin material in, for example, a long shape. As the resin material forming the pipe 12, polycarbonate resin mixed with a light diffusing material can be suitably used. As depicted in FIG. 2, the pipe 12 includes a pair of convex sections 12a on an inner surface of a part, which is an upper part in a state of use of the pipe 12.

The first cap 13a is attached to one end portion in a longitudinal direction of the pipe 12. The second cap 13b is attached to the other end portion in the longitudinal direction of the pipe 12. The first and second caps 13a and 13b are detachably connected to the sockets 4a and 4b. According to the connection, the lamp 11 supported by the sockets 4a and 4b is arranged right under the bottom plate section 5a of the reflecting member 5. A part of lights emitted to the outside from the lamp 11 are made incident on the side plate sections 5b of the reflecting member 5.

As depicted in FIG. 3, the first cap 13a includes two lamp pins 16a projecting to the outside of the first cap 13a. The lamp pins 16a are electrically insulated from each other. The distal end portions of the two lamp pins 16a are bent at a substantially right angle to separate from each other and formed in an L shape. As depicted in FIG. 3, the second cap 13b includes two lamp pins 16b projecting to the outside of the second cap 13b. The lamp pins 16b are electrically insulated from each other. The distal end portions of the two lamp pins 16b are bent at a substantially right angle to separate from each other and formed in an L shape.

The two lamp pins 16a of the first cap 13a are connected to the two terminal metal fittings 8 of the socket 4a and the two lamp pins 16b of the second cap 13b are connected to the two terminal metal fittings 9 of the socket 4b, whereby the lamp 11 is mechanically supported by the sockets 4a and 4b. In this supported state, power supply to the lamp 11 is enabled by the terminal metal fittings 8 in the socket 4a and the lamp pins 16a of the first cap 13a set in contact with the terminal metal fittings 8 and the terminal metal fittings 9 in the socket 4b and the lamp pins 16b of the second cap 13b set in contact with the terminal metal fittings 9.

The light-emitting elements 45a that emit lights of the same color are connected in series. An anode side of diodes of the light-emitting elements 45a is connected to a positive electrode of the first lighting circuit 3a by a wire 70a, which is an example of a first wire. A cathode side of diodes of the light-emitting elements 45a is connected to a negative electrode of the first lighting circuit 3a by a wire 70c, which is an example of a second wire. The light-emitting elements 45b that emit lights of the same color are connected in series. An anode side of diodes of the light-emitting elements 45b is connected to a positive electrode of the second lighting circuit 3b by a wire 70b, which is an example of a third wire. A cathode side of diodes of the light-emitting elements 45b is connected to a negative electrode of the second lighting circuit 3b by a wire 70d, which is an example of a fourth wire.

As depicted in FIG. 2, the beam 14 is housed in the pipe 12. The beam 14 is a bar material excellent in mechanical strength. For example, the beam 14 is formed of an aluminum alloy to reduce weight. Both ends in a longitudinal direction of the beam 14 are electrically insulated from and coupled to the first cap 13a and the second cap 13b.

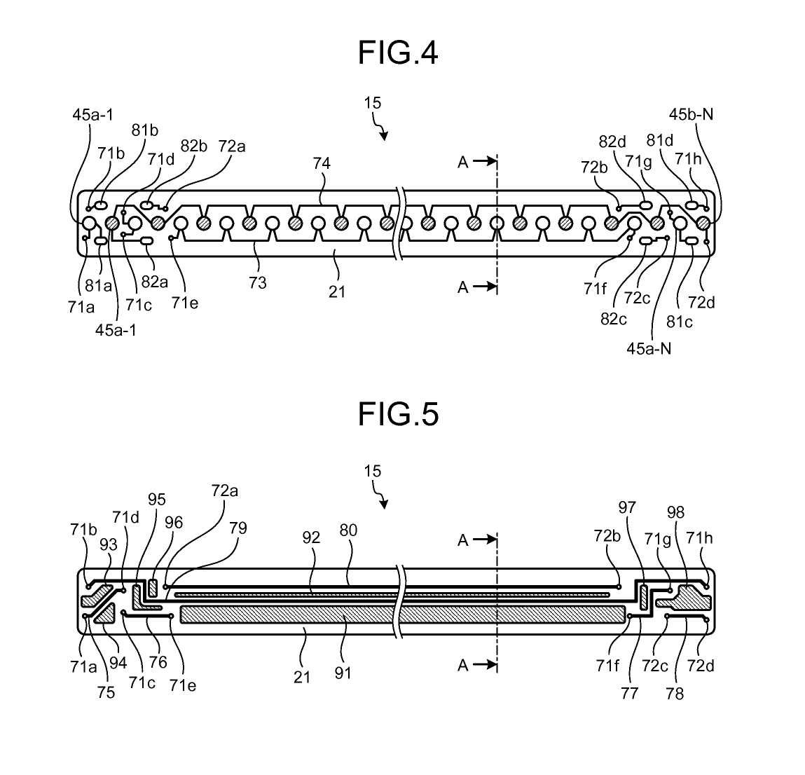

FIGS. 4 and 5 are diagrams depicting an example of a light-emitting module according to the embodiment. FIG. 4 is a diagram schematically depicting the configuration of a front surface side of the light-emitting module, that is, a surface side on which the light-emitting elements 45a and the light-emitting elements 45b are placed. FIG. 5 is a diagram schematically depicting the configuration of a rear surface side seen through from the front surface side of the light-emitting module. The plurality of light-emitting modules 15 are sometimes arranged in a row on the upper surface of a substrate 21 with the longitudinal direction of the light-emitting modules 15 set in a longitudinal direction of the substrate 21.

The light-emitting module 15 includes N (N is a natural number equal to or larger than 2) light-emitting elements 45a, which are a first group of light-emitting elements. The N light-emitting elements 45a are disposed in a row in a longitudinal direction from one end portion to the other end portion of the substrate 21, that is, from the left to the right in FIG. 4. The light-emitting elements 45a adjacent to each other are basically electrically connected by a conductive line 73. In the following explanation, the one end portion in the longitudinal direction of the substrate 21 is sometimes referred to as first end portion and the other end portion is sometimes referred to as second end portion.

The light-emitting module 15 includes N light-emitting elements 45b, which are a second group of light-emitting elements. The N light-emitting elements 45b are disposed in a row from the first end portion to the second end portion. The N light-emitting elements 45b are arranged alternately with the N light-emitting elements 45a. The light-emitting elements 45b adjacent to each other are electrically connected by a conductive line 74.

A terminal 81a is a positive electrode terminal corresponding to the first group and connected to the positive electrode of the first lighting circuit 3a. The terminal 81a is connected to a light-emitting element 45a-1 by a conduction line. Consequently, an electric current supplied from the first lighting circuit 3a can be supplied to the light-emitting element 45a-1. The N light-emitting elements 45a depicted in FIG. 4 are referred to as light-emitting element 45a-1 and light-emitting element 45a-2 in order from the light-emitting element 45a on the leftmost side. The light-emitting element 45a on the rightmost side is referred to as light-emitting element 45a-N.

The light-emitting element 45a-1 is connected to, via a conduction line, a through-hole 71a piercing through the substrates 21 from the front surface to the rear surface. The through-hole 71a is connected to a conductive line 75 on the rear surface of the substrate 21. The conductive line 75 is connected to the through-hole 71a at one end and connected to a through-hole 71d at the other end. The through-hole 71d is connected to the light-emitting element 45a-2 via a conductive line on the front surface of the substrate 21. In this way, the terminal 81a and the light-emitting element 45a-2 are electrically connected. A part of the conductive line configured to connect the light-emitting element 45a-1 and the light-emitting element 45a-2 is drawn around to the rear surface of the substrate 21 in this way. Consequently, it is possible to avoid three-dimensional collision of a light-emitting element 45b-1 arranged between the light-emitting element 45a-1 and the light-emitting element 45a-2 and the conductive line configured to connect the light-emitting element 45a-1 and the light-emitting element 45a-2.

The light-emitting element 45a-2 is connected to a light-emitting element 45a-3 via a through-hole 71c which are connected via a conduction line to the light-emitting element 45a-2, a conductive line 76, and a through-hole 71e. Consequently, it is possible to avoid three-dimensional collision of a light-emitting element 45b-2 arranged between the light-emitting element 45a-2 and the light-emitting element 45a-3 and a conductive line configured to connect the light-emitting element 45a-2 and the light-emitting element 45a-3.

The light-emitting element 45a-N is connected to a terminal 81c via a conduction line. The light-emitting element 45a-N is connected to a light-emitting element 45a-(N-1) via a through-hole 71g, a conductive line 77, and a through-hole 71f. Consequently, it is possible to avoid three-dimensional collision of a light-emitting element 45b-(N-1) arranged between the light-emitting element 45a-N and the light-emitting element 45a-(N-1) and a conductive line configured to connect the light-emitting element 45a-N and the light-emitting element 45a-(N-1). In this way, the terminal 81a and the terminal 81c are connected via the N light-emitting elements 45a connected in series.

When the light-emitting module 15 in which the terminal 81c is set is not a light-emitting module at the terminal end, the terminal 81c is connected to the terminal 81a of the next light-emitting module 15. On the other hand, when the light-emitting module 15 in which the terminal 81c is set is the light-emitting module at the terminal end, the terminal 81c is connected to a terminal 81d.

The terminal 81d is connected to a terminal 81b via a through-hole 71h, a conductive line 79, and a through-hole 71b. The terminal 81b is connected to the negative electrode of the first lighting circuit 3a. A first circuit corresponding to the light-emitting elements 45a is formed between the terminal 81a and the terminal 81b in this way. A conductive line configuring the first circuit is formed of, for example, copper. In the first circuit, the conductive line 79, which is a return line, is provided on the rear surface of the substrate 21.

On the other hand, a second circuit corresponding to the light-emitting elements 45b is formed between a terminal 82a and a terminal 82b as explained below.

The terminal 82a is a positive electrode terminal corresponding to the second group of light-emitting elements and connected to the positive electrode of the second lighting circuit 3b. The terminal 82a is connected to the light-emitting element 45b-1 by a conduction line. Consequently, an electric current supplied from the second lighting circuit 3b can be supplied to the light-emitting element 45b-1. The light-emitting element 45-1 is connected to the light-emitting element 45b-2 via the conductive line 74. The light-emitting elements 45b adjacent to each other are connected via the conductive line 74 in this way.

The light-emitting element 45b-N is connected to a terminal 82c via a through-hole 72d, a conductive line 78, and a through-hole 72c. Consequently, it is possible to avoid three-dimensional collision of a conductive line configured to connect the light-emitting element 45b-N and the terminal 82c and the light-emitting element 45a-N.

When the light-emitting module 15 in which the terminal 82c is set is not a light-emitting module at the terminal end, the terminal 82c is connected to the terminal 82a of the next light-emitting module 15. On the other hand, when the light-emitting module 15 in which the terminal 82c is set is the light-emitting module at the terminal end, the terminal 82c is connected to a terminal 82d.

The terminal 82d is connected to the terminal 82b via a through-hole 72b, a conductive line 80, and a through-hole 72a. The terminal 82b is connected to the negative electrode of the second lighting circuit 3b. The second circuit corresponding to the light-emitting elements 45b is formed between the terminal 82a and the terminal 82b. A conductive line configuring the second circuit is formed of, for example, copper. In the second circuit, the conductive line 80, which is a return line, is provided on the rear surface of the substrate 21.

The through-hole 71b and the through-hole 71h connected to both ends of the conductive line 79 are provided at one end portion in a latitudinal direction of the substrate 21, that is, on the upper side of FIGS. 4 and 5. In the following explanation, the one end portion in the latitudinal direction of the substrate 21 is sometimes referred to as third end portion and the other end portion is sometimes referred to as fourth end portion. The through-hole 72a and the through-hole 72b connected to both ends of the conductive line 80 are also provided at the third end portion of the substrate 21. The through-hole 71b and the through-hole 72a are provided at the one end portion of the substrate 21. The through-hole 71h and the through-hole 72b are provided at the second end portion.

The conductive line 79 and the conductive line 80 are provided more on the third end portion side than the fourth end portion side. In particular, in the configuration depicted in FIGS. 4 and 5, when the rear surface of the substrate 21 is equally divided into a region on the third end portion side and a region on the fourth end portion side, all the conductive line 79 and the conductive line 80 are disposed in the region on the third end portion side and are not disposed in the region on the fourth end portion side. That is, the conductive line 79 and the conductive line 80 are disposed unevenly on the third end portion side on the rear surface of the substrate 21. Consequently, it is possible to increase a free space in which the conductive line 79 and the conductive line 80 disposed from the first end portion to the second end portion are not disposed. A metal member 91 is disposed in the free space. That is, by disposing the conductive line 79 and the conductive line 80 unevenly on the third end portion side, it is possible to dispose the metal member 91 broadly in the free space. Consequently, since it is possible to increase the mechanical strength of the substrate 21, it is possible to prevent a bend of the substrate 21. Further, by disposing the conductive line 79 and the conductive line 80 unevenly on the third end portion side on the rear surface of the substrate 21, it is possible to reduce the lengths of the conductive line 79 and the conductive line 80.

A metal member 92 is disposed in a space between the conductive line 79 and the conductive line 80. As explained above, the conductive line 79 and the conductive line 80 are respectively connected to the light-emitting elements 45a and the light-emitting elements 45b of different kinds. Therefore, a large potential difference occurs between the conductive line 79 and the conductive line 80. It is likely that migration (corrosion) occurs in the conductive line 79 and the conductive line 80 because of the potential difference. Therefore, the metal member 92 is disposed in the space between the conductive line 79 and the conductive line 80 to generate intermediate potential in the metal member 92. Consequently, it is possible to suppress occurrence of migration in the conductive line 79 and the conductive line 80.

Similarly, in order to suppress migration of the conductive line 79 and the conductive line 80, a metal member 96 is provided in a free space between the conductive line 79 and the conductive line 80. In order to suppress migration of the conductive line 75 and the conductive line 79, a metal member 93 is provided in a free space between the conductive line 75 and the conductive line 79. In order to suppress migration of the conductive line 75 and the conductive line 76, a metal member 94 is provided in a free space between the conductive line 75 and the conductive line 76. In order to suppress migration of the conductive line 76 and the conductive line 79, a metal member 95 is provided in a free space between the conductive line 76 and the conductive line 79. In order to suppress migration of the conductive line 79 and the conductive line 77, a metal member 97 is provided in a free space between the conductive line 79 and the conductive line 77. In order to suppress migration of the conductive line 79 and the conductive line 78, a metal member 98 is provided in a free space between the conductive line 79 and the conductive line 78.

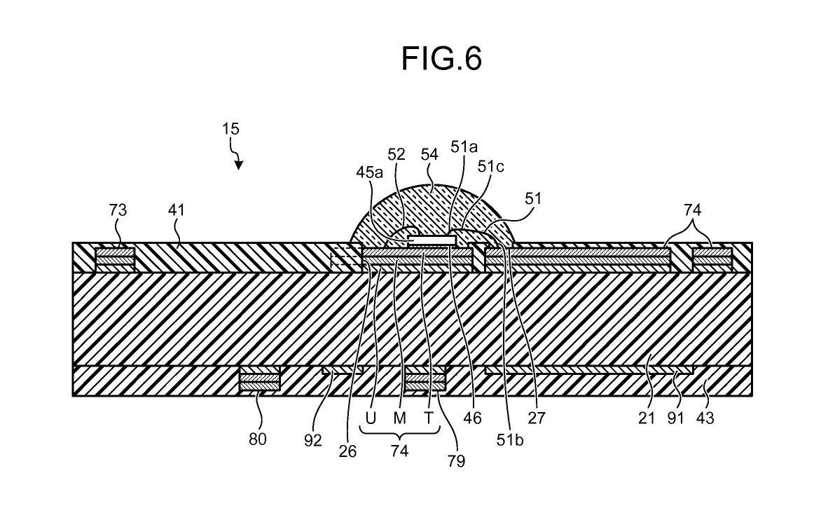

FIG. 6 is a sectional view of the light-emitting module taken along line A-A in FIGS. 4 and 5. A sectional view taken along a line passing through the light-emitting elements 45a is explained below. A sectional view taken along a line passing through the light-emitting elements 45b is the same. Therefore, explanation is omitted concerning the sectional view taken along the line passing through the light-emitting elements 45b.

As depicted in FIG. 6, the light-emitting module 15 includes the conduction lines 73, 74, 79, and 80, protecting members 41 and 43, the metal members 91 and 92, the light-emitting elements 45a, a first wire 51, a second wire 52, and a sealing member 54.

The substrate 21 is made of a flat plate formed of electrically insulative resin, for example, glass epoxy resin. A substrate (FR-4) made of the glass epoxy resin is low in heat conductivity and relatively inexpensive. The substrate 21 may be formed of a glass composite substrate (CEM-3) or other synthetic resin materials.

The conductive line 74 is formed in a three-layer structure and formed on the front surface of the substrate 21. A first layer U is formed of plated copper on the front surface of the substrate 21. A second layer M is plated on the first layer U and formed of nickel. A third layer T is plated on the second layer M and formed of silver. Therefore, the surface of the conductive line 74 is made of silver. The third layer T made of silver forms a reflection surface. The total light reflectance of the third layer T is equal to or higher than 90%.

Like the conductive line 74, the conductive line 73 is formed in a three-layer structure and formed on the front surface of the substrate 21.

In the protecting member 41, for example, a white resist layer containing electrically insulative synthetic resin as a main component can be suitably used. The white resist layer functions as a reflection layer having high light reflectance. The protecting member 41 is formed on the substrate 21 to cover most portions of the conduction lines 73 and 74.

Mounting pads 26 and conductive connection sections 27 are formed in portions where the third layer T is exposed without being covered with the protecting member 41 at a stage when the protecting member 41 is formed on the substrate 21. The mounting pads 26 are arranged in the longitudinal direction of the substrate 21. The conductive connection sections 27 form pairs with the mounting pads 26 and are respectively disposed near the mounting pads 26. Therefore, the conductive connection sections 27 are arranged in the longitudinal direction of the substrate 21 at a disposing pitch same as a disposing pitch of the mounting pads 26.

The light-emitting element 45a includes a bare chip of an LED. The bare chip of the LED includes a light-emitting layer on one surface of an element substrate made of sapphire. A plane shape of the bare chip of the LED is a rectangular shape.

In the light-emitting element 45a, the other surface of the element substrate on the opposite side of the one surface is fixed to the mounting pad 26, which is a reflection surface, using an adhesive 46. The light-emitting element 45a forms a light-emitting element row arranged in the longitudinal direction of the substrate 21 (a direction in which a center axis extends).

A bonding part of the light-emitting element 45a is preferably the center of the mounting pad 26. Consequently, light emitted from the light-emitting element 45a and made incident on the mounting pad 26 can be reflected in a reflection surface region around the light-emitting element 45a. In this case, the light made incident on the mounting pad 26 is more intense as the light is closer to the light-emitting element 45a. The intense light can be reflected on the reflection surface region.

Light emission of the light-emitting element 45a including the bare chip of the LED is realized by feeding a forward current to a p-n junction of a semiconductor. Therefore, the light-emitting element 45a is a solid-state element that converts electric energy into direct light. The light-emitting element 45a that emits light according to such a light emission principle has an energy saving effect compared with an incandescent lamp that makes a filament incandescent at high temperature through energization and emits visible light with heat radiation of the filament.

The adhesive 46 preferably has heat resistance in obtaining durability of bonding. Further, the adhesive 46 preferably has translucency in order to enable reflection even right under the light-emitting element 45a. As the adhesive 46, a silicone resin-based adhesive can be used.

The first wire 51 and the second wire 52 are made of a metal thin wire, for example, a thin wire of gold and wired using a bonding machine.

The first wire 51 is provided to electrically connect the light-emitting element 45a and the conductive connection section 27 of the conductive line 74. In this case, one end portion 51a of the first wire 51 is connected to an electrode of the light-emitting element 45a by first bonding. The other end portion 51b of the first wire 51 is connected to the conductive connection section 27 by second bonding.

The one end portion 51a of the first wire 51 is projected in the thickness direction of the light-emitting element 45a to separate from the light-emitting element 45a.

An intermediate portion 51c of the first wire 51 is a portion between the one end portion 51a and the other end portion 51b. As depicted in FIG. 6, the intermediate portion 51c is formed to bend from the one end portion 51a to be parallel to the light-emitting element 45a.

The second wire 52 is provided to connect the light-emitting element 45a and the mounting pad 26 formed by a part of the conductive line 74 through wire bonding. In this case, one end portion of the second wire 52 is connected to the other electrode of the light-emitting element 45a by first bonding. The other end portion of the second wire 52 is connected to the mounting pad 26 by second bonding.

Therefore, the N light-emitting elements 45a mounted on the substrate 21 of the light-emitting module 15 are electrically connected. The N light-emitting elements 45a emit lights when electric power is supplied from the first lighting circuit 3a.

In FIG. 6, when focusing on the rear surface side of the substrate 21, the conductive line 79 is formed in a three-layer structure and formed on the rear surface of the substrate 21. The three-layer structure is the same as the three-layer structure of the conductive line 74. Like the conductive line 79, the conductive line 80 is formed in a three-layer structure and formed on the rear surface of the substrate 21.

Further, the metal members 91 and 92 are formed on the rear surface of the substrate 21. The metal members 91 and 92 are preferably formed of copper like the first layer U of the conduction lines 79 and 80. Consequently, the metal members 91 and 92 can be formed in a manufacturing process same as the manufacturing process for the first layer U of the conduction lines 79 and 80. However, as explained above, the metal member 91 is provided to suppress a bend of the substrate 21. Therefore, the metal member 91 only has to be formed of a material having high rigidity. The material is not limited to copper. As explained above, the metal member 92 is provided to suppress corrosion of the conductive line 79 and the conductive line 80 with intermediate potential. Therefore, the metal member 92 only has to be made of a material of an electrical conductor. The material is not limited to copper.

The protecting member 43 is laminated to extend over the peripheral rear surface of the substrate 21, the conduction lines 79 and 80, and the metal members 91 and 92. The protecting member 43 is formed of an insulating material, for example, a resist layer made of synthetic resin.

As explained above, according to this embodiment, the light-emitting module 15 includes the metal member 91 provided in the longitudinal direction of the substrate 21 in a position not overlapping the conductive line 79 on the rear surface of the substrate 21.

With the configuration of the light-emitting module 15, it is possible to reinforce the substrate 21 with the metal member 91 that is unrelated to the first circuit corresponding to the light-emitting elements 45a, that is, electrically nonconductive. Therefore, it is possible to suppress a bend of the substrate 21 without deteriorating light emission efficiency of the light-emitting module 15. The conductive line 79 equivalent to the return conductive line of the first circuit corresponding to the light-emitting elements 45a can be distributed on the rear surface of the substrate 21. Therefore, it is possible to reduce the width in the latitudinal direction of the substrate 21. That is, it is possible to reduce the size of the light-emitting module 15. The same holds true concerning the conductive line 80.

On the rear surface of the substrate 21 of the light-emitting module 15, the conductive line 79 is disposed more on the other end side (i.e., the four end portion side) than one end side (i.e., the third end portion side) in the latitudinal direction of the substrate 21. That is, on the rear surface of the substrate 21 of the light-emitting module 15, the conductive line 79 is disposed unevenly on the third end portion side.

With the configuration of the light-emitting module 15, it is possible to dispose the metal member 91 broadly in a free space where the conductive line 79 disposed from the first end portion to the second end portion is not disposed. Consequently, since the strength of substrate 21 can be efficiently reinforced, it is possible to efficiently prevent a bend of the substrate 21. The same holds true concerning the conductive line 80.

The light-emitting module 15 includes the electrically nonconductive metal member 92 in a region between the conductive line 79 and the conductive line 80 on the rear surface of the substrate 21.

With the configuration of the light-emitting module 15, it is possible to suppress corrosion of the conductive line 79 and the conductive line 80.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light-emitting module comprising:
a substrate formed of insulative resin;
a first group of light-emitting elements disposed in a longitudinal direction from a first end portion to a second end portion of the substrate on a first surface of the substrate, the light-emitting elements of the first group being connected in series to one another;
a second conductive line disposed from the one end portion to the second end portion on a second surface of the substrate on an opposite side of the first surface and electrically connected to, via a first through-hole, a first conductive line configured to connect the light-emitting elements of the first group on the first surface; and
an electrically nonconductive first metal member disposed in the longitudinal direction in a position not overlapping the second conductive line on the second surface.

2. The module according to claim 1, wherein
on the second surface of the substrate, the second conductive line is disposed more on the other end side than one end side in a latitudinal direction of the substrate, and
the first metal member is disposed more in a region on the one end side than the other end side of the second surface.

3. The module according to claim 2, further comprising:
a second group of light-emitting elements disposed in the longitudinal direction on the first surface, the light-emitting elements of the second group being connected in series to one another; and
a fourth conductive line disposed from the first end portion to the second end portion on the second surface and electrically connected to, via a second through-hole, a third conductive line configured to connect the light-emitting elements of the second group on the first surface, wherein
on the second surface, the fourth conductive line is disposed more on the other end side than the one end side in the latitudinal direction of the substrate.

4. The module according to claim 3, further comprising an electrically nonconductive second metal member disposed in a region on the second surface between the second conductive line and the fourth conductive line.

5. The module according to claim 3, wherein
the first conductive line includes a first partial line disposed on the first surface and a second partial line disposed on the second surface, and
the second partial line three-dimensionally crosses the third conductive line.

6. The module according to claim 5, wherein the first partial line and the second partial line are electrically connected via another through-hole.

7. The module according to claim 5, further comprising an electrically nonconductive third metal member disposed in a region on the second surface between the first partial line and the fourth conductive line.

8. The module according to claim 3, wherein the first group of light-emitting elements and the second group of light-emitting elements have different light emission colors.

9. The module according to claim 1, further comprising
a second group of light-emitting elements disposed in the longitudinal direction on the first surface, the light-emitting elements of the second group being connected in series to one another; and
a fourth conductive line disposed from the first end portion to the second end portion on the second surface and electrically connected to, via a second through-hole, a third conductive line configured to connect the light-emitting elements of the second group on the first surface, wherein
the first metal member is disposed in a region on the second surface between the second conductive line and the fourth conductive line.

10. A luminaire comprising a light emitting module including:
a substrate formed of insulative resin;
a first group of light-emitting elements disposed in a longitudinal direction from a first end portion to a second end portion of the substrate on a first surface of the substrate, the light-emitting elements of the first group being connected in series to one another;
a second conductive line disposed from the one end portion to the second end portion on a second surface of the substrate on an opposite side of the first surface and electrically connected to, via a first through-hole, a first conductive line configured to connect the light-emitting elements of the first group on the first surface; and
an electrically nonconductive first metal member disposed in the longitudinal direction in a position not overlapping the second conductive line on the second surface.

11. The luminaire according to claim 10, wherein
on the second surface of the substrate, the second conductive line is disposed more on the other end side than one end side in a latitudinal direction of the substrate, and
the first metal member is disposed more in a region on the one end side than the other end side of the second surface.

12. The luminaire according to claim 11, wherein
the light-emitting module further includes:
a second group of light-emitting elements disposed in the longitudinal direction on the first surface, the light-emitting elements of the second group being connected in series to one another; and
a fourth conductive line disposed from the first end portion to the second end portion on the second surface and electrically connected to, via a second through-hole, a third conductive line configured to connect the light-emitting elements of the second group on the first surface, and
on the second surface, the fourth conductive line is disposed more on the other end side than the one end side in the latitudinal direction of the substrate.

13. The luminaire according to claim 12, further comprising an electrically nonconductive second metal member disposed in a region on the second surface between the second conductive line and the fourth conductive line.

14. The luminaire according to claim 10, wherein
the luminaire includes a plurality of the light-emitting modules, and
a first light-emitting module and a second light-emitting module of the light-emitting modules are arranged in a row in the longitudinal direction and electrically connected.

15. The luminaire according to claim 10, wherein
the light-emitting module further includes:
a second group of light-emitting elements disposed in the longitudinal direction on the first surface, the light-emitting elements of the second group being connected in series to one another; and
a fourth conductive line disposed from the first end portion to the second end portion on the second surface and electrically connected to, via a second through-hole, a third conductive line configured to connect the light-emitting elements of the second group on the first surface, and
the luminaire further comprises:
a first lighting circuit configured to supply electric power to the first group of light-emitting elements; and
a second lighting circuit configured to supply electric power to the second group of light-emitting elements.
